(19) United States
(12) Patent Application Publication
(10) Pub. No.: US 2015/0303540 A1
(43) Pub. Date: Oct. 22, 2015

(54) PROCESS AND SYSTEMS FOR STABLE OPERATION OF ELECTROACTIVE DEVICES

(71) Applicants: THE REGENTS OF THE UNIVERSITY OF CALIFORNIA, Oakland, CA (US); HYPERSOLAR, INC., Santa Barbara, CA (US)

(72) Inventors: Syed Mubeen Jawahar Hussaini, Chennai (IN); Tim Young, Santa Barbara, CA (US); Eric McFarland, Santa Barbara, CA (US); Nirala Singh, Santa Barbara, CA (US); Joun Lee, Santa Barbara, CA (US); Martin Moskovits, Santa Barbara, CA (US)

(21) Appl. No.: 14/426,594

(22) PCT Filed: Sep. 6, 2013
(86) PCT No.: PCT/US13/58620

§ 371 Date: Mar. 6, 2015

Related U.S. Application Data
(60) Provisional application No. 61/697,752, filed on Sep. 6, 2012.

(51) Int. Cl. H01M 14/00; H01G 9/20; C25B 9/00

(52) U.S. Cl. CPC H01M 14/005; C25B 9/00; H01G 9/20

(57) ABSTRACT

Disclosed is a polymer coating that can be used to stabilize the operation of electroactive devices. The coating can be electrically conductive and optically transparent. The coating can be a polymer such as PEDOT:PSS, and the polymer can be doped or undoped. The coating can help facilitate PEC and PS reactions that form electrical energy or other chemicals. The coating can additionally be used for coating other electroactive devices.

### BACKGROUND

1. Field

Embodiments of the present disclosure generally relate to stable coatings for electroactive devices, and methods for coating said devices.

2. Description of the Related Art

There have been attempts to manufacture stable electroactive units for electricity generation or for production of fuels and chemicals. However, development of environmentally and economically sustainable energy sources using solar energy is still an important unmet challenge. Today there are no cost-effective solar photoelectrochemical (PEC) systems that incorporate a high efficiency absorber in a configuration that produces potentially valuable fuel or chemical. For example, metals, or metal oxides, have been used to cover electroactive devices. However, metal layers have difficulty in remaining in contact with an absorber layer, such as a semiconductor. Therefore, a large amount of metal is required to be put on the absorber. This large amount of metal creates a thicker barrier, which decreases the overall transparency. Therefore, the metal layer does not create an efficient electroconductive and optically transparent layer. Further, using metals and metal oxides is extremely expensive, and can quickly become cost prohibitive.

Although there exist increasingly efficient and less costly semiconductors for used in photovoltaic applications (e.g. Si, Cu₂S, CdSe, CdTe, SnS etc.), a major challenge is stabilizing these high efficiency materials against photocorrosion when operating in an electrochemical environment of a PEC cell.

### SUMMARY

A stabilized electroactive system comprising an electroactive device and an electrolyte solution contacting at least a portion of the polymer coating is disclosed. The electroactive device comprises an electrochemically active surface, a electrochemically active material, and a polymer coating disposed over the electrochemically active material; wherein the polymer coating is electrically conducting, optically transparent, and corrosion resistant. In some embodiments, the system further comprises a counter electrode. In some embodiments, the electroactive device further comprises a reduction electrocatalyst material disposed on an opposite side of the semiconductor layer. In some embodiments, the polymer coating is disposed on the electrochemically active material. In some embodiments, the electroactive device further comprises a transparent substrate disposed on the polymer coating.

A stabilized electroactive system comprising a plurality of electroactive devices and an electrolyte solution contacting at least a portion of a polymer coating is disclosed. In some embodiments, the plurality of electroactive devices is disposed in pores of a porous structure. Each of the plurality of electroactive devices comprises an electrochemically active surface, a electrochemically active material, and a polymer coating disposed over the electrochemically active material; wherein the polymer coating is electrically conducting, optically transparent, and corrosion resistant. In some embodiments, each of the electroactive devices further comprises a reduction electrocatalyst material disposed on an opposite side of the electrochemically active material.

A stabilized electroactive system comprising an optically transparent substrate, a conductive layer disposed on the optically transparent substrate, a electrochemically active material disposed on the conductive layer, and a counter electrode is also disclosed. In some embodiments, the counter electrode comprises a polymer coating disposed on a second transparent substrate. In some embodiments, the conductive layer comprises the polymer coating. The polymer coating is electrically conducting, optically transparent, and corrosion resistant.

A stabilized electroactive system comprises a cathode, a cathode current collector, an anode, an anode current collector, and an electrolyte in contact with the cathode and the anode; wherein one or both of the cathode current collector and the anode current collector comprises a polymer coating material that is electrically conducting and optically transparent.

A stabilized electroactive system comprises an anode catalyst layer, a cathode catalyst layer, and a proton exchange membrane between the anode catalyst layer and the cathode catalyst layer; wherein the cathode catalyst layer comprises a polymer coating material.

### BRIEF DESCRIPTION OF THE DRAWINGS

FIG. 1 illustrates an embodiment of a stable photoelectrochemical (PEC) system and the process for producing energy from electromagnetic radiation.

FIG. 2 illustrates an embodiment of a stable artificial photosynthetic system and the process for producing energy from electromagnetic radiation.

FIGS. 3A-E illustrates an embodiment of a process for forming a stable artificial photosynthetic system.

FIGS. 4A-B illustrates an embodiment of a stable solar battery and the process for producing energy from electromagnetic radiation.

FIG. 5 illustrates a cross sectional SEM image of an embodiment of a functional coating.

FIG. 6A illustrates a schematic representation of an embodiment of a PEC photoanode.

FIG. 6B illustrates a band diagram corresponding to the photoanode in FIG. 6A.

FIG. 7 illustrates electronic transfer kinetics of an embodiment of a functional coating film on an ITO electrode and an ITO electrode without a coating.

FIG. 8 illustrates photoelectric performance of an embodiment of a Si/functional coating composite anode and an n-Si anode in different electrolyte solutions.

FIGS. 9A-B illustrate stability tests and measured potentials of an embodiment of functional coating.

FIG. 10A illustrate the surfaces of a planar Si wafer and a a nanostructured Si wafer (containing Si nanowires).

FIG. 10B is a cross sectional SEM image of the nanostructured Si wafer surface.

FIG. 11 illustrates effects of nanostructuring on photoeletrochemical performance of an embodiment of an n-Si/functional coating system.

FIG. 12A illustrates an embodiment of a PEC device.

FIGS. 12B-C illustrate the testing results of an embodiment of a functional coating covered system.

### DETAILED DESCRIPTION

The present disclosure is directed towards processes and systems for stabilizing the operation of electrical, electrochemical, photoelectrochemical and photosynthetic devices, which can increase efficiency while maintaining low costs. In particular, disclosed are functional coating materials and applications of those coatings onto electroactive devices. The functional coatings can increase efficiency and provide long term operational stability to the electroactive devices. Further, the coating, which when disposed on an electroactive device, can stabilize the device from electrical/chemical/electrochemical/photo degradation providing exceptional operational performance. The stabilization can be done without negatively affected the performance of the electroactive device in other aspects. The functional coatings can be located on electrochemically active surfaces such as, for example, electrodes, and can be used to absorb sunlight and use the absorbed energy to drive production of fuels and other valuable chemicals. In some embodiments, the functional coating can be used as an anti-static device if it is, for example, disposed on glass.

The terms “approximately”, “about”, and “substantially” as used herein represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

When a first layer is “over,” “positioned over,” or “disposed over” a second layer or a substrate, the first layer may be directly on/contacting the second layer or the substrate, or there may be one or more other layers at least partially disposed between the first layer and the second layer or the substrate. When a first layer is “on,” “positioned on,” or “disposed on” the second layer or the substrate, the first layer and the second layer or the substrate is at least partially in contact.

In some embodiments, the functional coating described in detail below can be used to cover electroactive devices such as, for example, photoelectrochemical (PEC) or photosynthetic (PS) cells. PEC/PS cells can be used in many types of devices such as, for example, solar panels or solar energy conversion devices. An electroactive device generally comprises an electrochemically active surface, an optional current collector (for example if the electrochemically active surface does not have sufficient electrical conductivity), a functional coating material, and an electrolyte. The functional coating material is described in further detail below, and can be used to protect the electroactive surface from electrochemical corrosion, and can also serve to improve the electrical conductivity of an electrode, or even serve as an electrochemically active electrode.

PEC/PS cells can be used to generate electrical energy or chemicals products by converting light or other electromagnetic radiation as a sustainable energy source. In some embodiments, visible light can be used to initiate a reaction, although the type of light is not limiting. For example, UV and infrared light could be used as well. A PEC/PS cell can absorb the electromagnetic radiation to perform, for example, electrolysis of water to form hydrogen and oxygen gasses. Energy is stored in an energy carrier in chemical bonds, such as the produced hydrogen gas, which can further be used as a fuel source. In some embodiments, the PEC/PS cell can produce fuels or other chemicals at a solar to fuel conversion efficiency of at least about 1%, at least about 5%, at least about 10%, or at least about 15%. In some embodiments, the solar to fuel conversion efficiency can be from about 1% to about 30%, from about 1% to about 15%, or from about 10 to about 15%. Fuel conversion efficiency can be defined as: ((rate of fuel production)*(change in Gibbs free energy/mole of fuel))/((solar energy input)*(illuminated electrode area)). Further, the PEC/PS cell can be used to perform evolution of specific chemicals/compositions. For example, the PEC/PS cell can be configure for bromine or hydrogen evolution to produce energy.

In some embodiments, an electroactive device can form, but not limited to, H₂ (from, for example, water, hydrohalic acids, or organic waste), Cl₂ (for example from HCl electrolysis), Br₂ (for example from HBr electrolysis), I₂ (for example from HI electrolysis), methanol (for example from CO₂ reduction), and methane (for example by reacting H₂ with CO₂). However, other useful fuels can be formed.

In some embodiments, a semiconductor can be used in a PEC/PS cell. The semiconductor can act as a photoactive material. A surface of the semiconductor can absorb electromagnetic radiation, such as solar energy, and can act as an electrode for water splitting or chemical evolution. The more electromagnetic radiation that can be absorbed, the higher efficiency the PEC/PS cell can have. Therefore, a coating on the semiconductor array that does not substantially diminish the amount of radiation that reaches the semiconductor is advantageous.

For example, in some embodiments of the present disclosure, a functional coating material can be disposed on a carbon support as an electrocatalyst for fuel cell applications. This system can help commercial fuel cell markets in replacing expensive metallic catalysts, such as platinum or other expensive metals. In some embodiments, the functional coating material can be positioned on a carbon support as a stable current collector for battery applications, leading to development of flexible and light weight batteries. In some embodiments, the coating material can be disposed on a glass and can serve as a stable transparent conducting substrate for solar cell applications. This type of system can help solar cell companies in replacing expensive transparent conducting oxide substrates such as indium tin oxide or fluorine doped tin oxide.

Embodiments of the present disclosure can allow various industrial plants or wastewater treatment facilities (that produce/host large streams of electrolyte containing bromine, chlorine, hydrogen ions) to utilize sunlight as a source for onsite electricity generation or produce hydrogen that can be sold in the $150 billion/year global hydrogen market. Additionally halogens produced by embodiments of the disclosure can be used by the chemical and petrochemical companies for subsequent fuel production. For example, bromine is used in the chemical industry for activation of C—H bonds for conversion of natural gas to various liquid hydrocarbons with hydrobromic acid as waste product. Also, petrochemical companies can combine the resulting hydrogen with captured carbon dioxide to produce pipeline ready methane fuel. Embodiments of the disclosure can further allow photovoltaic (PV) industries to utilize current solar cells for production of storable valuable fuels and other valuable chemicals in addition to electricity generation.

Additionally, embodiments of the disclosure can influence the industrial sector for development of new semiconductor materials, electrocatalysts, and protective coatings for various applications. The disclosed processes are highly scalable, and can be used to construct a system of any size, and the size is not limiting. For example, a system can be made using embodiments of the above disclosure and can be about 1 meter×about 1 meter in solar area. Other embodiments can be larger, such as about 5 meter×about 5 meter, about 10 meter×about 10 meter, about 50 meter×about 50 meter, and about 100 meter×about 100 meter.

### Functional Coating Material

In some embodiments, a functional coating material can be used on top of an electroactive device or layer. This functional coating material can be used to increase the overall stability of the electroactive device or layer by, for example, forming a protective layer around the device. The functional coating can be formed from a material which meets some of the following criteria: 1) optically transparent in a range of wavelength of interest (e.g., visible, UV, etc.), 2) stable under different corrosive environments, 3) electronically conductive, 4) electrocatalytically active on its own, and 5) thermally stable. In some embodiments, the coating can be made of cheap and earth abundant material that can be made easily processable for conformal application on different film morphologies, among other criteria. However, the above criteria are not limiting, and are merely illustrative.

In general, the functional coating can have certain properties useful for coating an electroactive device. For example, the functional coating can be generally optically transparent. In some embodiments that utilize visible light sources, the visible light transparency of the coating can be about 60, about 65, about 70, about 75, about 80, or about 85%. In some embodiments, the coating can be at least about 60, at least about 65, at least about 70, at least about 75, at least about 80, or at least about 85% transparent. This can allow sunlight, artificial light, or other radiation to pass through the functional coating to an absorber layer underneath. If the functional coating was not transparent, there could be an overall decrease in the efficiency of an electroactive device.

Further, the functional coating can be electrically conductive. In some embodiments, the conductivity of the functional coating can be about 500, about 600, about 700, about 800, about 900, about 1000, or about 1100 S cm⁻¹. In some embodiments, the functional coating can be at least about 500, at least about 600, at least about 700, at least about 800, at least about 900, at least about 1000, or at least about 1100 S cm⁻¹. Therefore the functional coating can be electrically integrated into an electroactive device. In some embodiments, the functional coating may be both electrically conductive and optically transparent. In some embodiments, the functional coating can also have a stable voltage window, which can reduce inefficiencies and instability in an electroactive device. In some embodiments, the functional coating can absorb specific unbound electrolyte species (e.g., X⁻ in HX) and combine them to form a pair, e.g. X₂. In some embodiments, this reaction can speed up the formation of X₂ from individual ions.

The coating can also act as a protective coating for the electroactive device. With this functional coating, the device can be used in a corrosive environment without significant decrease in efficiency, and remains stable for a substantially period of time. For example, the coating can prevent direct contact of the electrolyte and the semiconductor/electrode material, as well as other components. In some embodiments, the function coating can be ion-selective, allowing certain species of ions to pass through, while preventing others.

In some embodiments, the coating material can also be electrocatalytically active, energetically forming a type-II band offset with the underlying semiconductor layer. In some embodiments, the functional coating material is also stable in acidic and/or basic electrolytes. In some embodiments, the functional coating materials may include, but are not limited to, Poly(3,4-ethylenedioxythiophene) (PEDOT) in natural and doped form, Poly(4,4-dioctylcyclopentadithiophene) in natural and doped form, metallic carbon nanotubes (CNTs) in natural or doped form, or combinations thereof. The dopants for PEDOT can include, but are not limited to, poly(styrene sulfonate) (PSS), tetra methacrylate (TMA), perchlorate or combinations thereof. The dopants for Poly(4,4-dioctylcyclopentadithiophene) may include, but are not limited to iodine, 2,3-dichloro-5,6-dicyano-1,4-benzoquinone (DDQ), and combinations thereof. In some embodiments, CNTs can be doped to be either metallic or semiconducting. While the below disclosure mainly recites the use of PEDOT:PSS coatings, a person having ordinary skill in the art would understand that other similar coatings could readily be used as well, and the specific coating is not limiting. For example, polymers which are conductive and transparent can be used as the protective coating. For example, other conducting polymers such as polyaniline or polypyrrole can be used. In some embodiments, they can be disposed as a film of under about 10 nm in thickness, for example.

In some embodiments, the functional coating can be disposed directly on top of an electroactive device or layer. The coating material is dispersed in a mixture of aqueous/non-aqueous solvent and homogenized. The coating mixture can then be disposed conformally and easily onto such an electroactive device or layer. For example, the functional coating can be disposed by spin casting, spray painting, drop casting, vapor phase polymerization, electro polymerization, light initiated electro polymerization or combinations thereof. The listed methods are not limiting, and other methods can be used to dispose the functional coating on the electroactive device or layer.

In some embodiments, the process of forming a conformal functional coating on top of the electroactive layer further comprises an annealing process. The disposed functional coating is annealed for about 10 to about 100 minutes, about 10 to about 80 minutes, about 10 to about 60 minutes, about 10 to about 40 minutes, about 10 to about 30 minutes, or about 10 to about 20 minutes in ambient, in an inert gas or in vacuum environment. In some embodiments, the annealing time may be about 10, about 20, about 30, about 40, about 50, about 60, about 70, about 80, about 90, or about 100 minutes. The annealing temperature maybe at about 100° C., about 110° C., about 120° C., about 130° C., about 140° C., or about 150° C. In some embodiments, the annealing temperature may be at about 100 to about 200° C., about 100 to about 180° C., about 110 to about 180° C., or about 100 to about 150° C.

In some embodiments, the functional coating can further be treated to strengthen the coating surface. For example, some coatings may be water soluble, and can be treated to be made water-insoluble. In an example where the coating is PEDOT:PSS, the coating can be dipped in ethylene glycol (EG) to render the polymer film water-insoluble.

In some embodiments, the functional coating can be disposed on an electroactive device with a thickness of between about 10 nm to about 2 μm, between about 20 nm to about 1.5 μm, about 30 nm to about 1 μm, about 40 nm to about 90 nm, or about 50 nm to about 80 nm. In some embodiments, the thickness may also be approximately 10 nm, approximately 20 nm, approximately 30 nm, approximately 40 nm, approximately 50 nm, approximately 60 nm, approximately 70 nm, approximately 80 nm, approximately 90 nm, approximately 1 um, approximately 1.5 um, or approximately 2 um. In some embodiments, the thickness can be greater than approximately 10 nm. The increase in thickness does not substantially affect the transparency, or other properties, of the functional coating.

Tunability of Functional Coating

In some embodiments, the polymer used in the functional coating can be highly tunable. For example, the functional coating described below can be tuned to be water soluble or water insoluble. Further, the electrical conductivity of the polymer can be tuned as desired. This can allow for the functional coating to be used in applications for different electroactive devices under different conditions.

In some embodiments of the present disclosure, the conductivity of the functional coating polymer can be enhanced by dipping the polymer in organic solvents such as, but not limited to, dimethylsulfoxide (DMSO), methyl sulfoxide, ethylene glycol (EG), poly(ethylene glycol) (PEG), 2-nitroethanol, 1-methyl-2-pyrrolidinone, N,N-dimethylformamide (DMF), glycerol, sorbitol and combinations thereof. By tuning the electronic conductivity and electrocatalytic activity of the functional composite coating material, it can be used as a light weight, corrosion resistant, inexpensive electrode in fuel cells and batters. In some embodiments, tuning can be performed by removing or adding insulating PSS chains. For example, if more insulating PSS chains are added, the coating can be less conducting.

In some embodiments, the conductivity of the functional coating polymer can also be enhanced by introducing dopants. For PECOT coating, useful dopants include styrene sulfonate (PSS), tetra methacrylate (TMA), perchlorate, and combinations thereof For poly(4,4-dioctylcyclopentadithiophene) coating, useful dopants may include iodine, 2,3-dichloro-5,6-dicyano-1,4-benzoquinone (DDQ), and combinations thereof.

Additionally, in some embodiments of the present disclosure, the electrocatalytic activity of the functional polymer can be enhanced by adding materials such as, for example, platinum, iridium, ruthenium, ruthenium oxide, ruthenium sulfides, rhodium sulfide, and combinations thereof. In such embodiments, the material can be added as nanoparticle inclusions during the coating of an electroactive device or added on top upon completion of coating an electroactive device. The functional composite catalyst can be disposed by co-electrodeposition, vapor phase deposition, spin casting, drop casting, spray painting, photochemical synthesis or combinations thereof.

In some embodiments where the functional coating is used as a catalyst for hydrogen evolution, a protective coating can be added to cover the electrocatalyst to preferentially allow protons and hydrogen to pass through, blocking the oxidation products from being reduced and thus increasing the Faradaic efficiency for production of hydrogen. The protective coating can act as an ion-selective membrane (e.g., semipermeable coating), thereby allowing/transporting selective ions and preventing unwanted back reactions. This can generally improve the electrochemical efficiency of the system. In some embodiments, the protective coating used can comprise chromium oxide, poly methyl meth acrylate (PMMA) and a combination thereof.

Further, in some embodiments of the present disclosure, the functional conducting polymer coating can form a Schottky contact with the semiconductor absorber layer for PEC/PS applications. In such embodiments, the work function of the functional coating can be tuned by changing the dopant concentration such that its work function is lower than the Fermi level of the semiconductor. The process of changing the dopant concentration can be done by, for example, chemical/electrochemical methods. In one embodiment, the work function of the functional coating can be tuned in such a way that it acts as an efficient hole transport layer and as an electron blocking layer for PEC/PS applications. The dopant concentration can control the work function of the polymer. Hence, by doping or dedoping the polymer, the work function of the material can be increased or decreased. Further, a conducting polymer with a higher work function can act as a hole transporter, whereas a polymer with a lower work function can act as a hole blocking layer.

Described above are examples of tuning abilities of embodiments of the functional coating. However, the coating can be tuned for other properties as well, and the nature and use of the tuning is not limited.

Electro catalysis of Redox Reactions

In some embodiments of the present disclosure, the functional coating can act as an electrocatalytically active material that may form the active surface of an electrode. The catalytic reactions include, but are not limited to, water oxidation, iodine-iodide redox reaction, bromine evolution, hydrogen evolution, oxygen reduction, ferrocene-ferrocenium redox reaction, hydroquinone oxidation, redox reaction of hydrogen peroxide, vanadia redox couple, etc.

### Stabilized Electroactive Device

In some embodiments, the functional coating can be used to stabilize a photoelectrochemical (PEC)/photosynthetic (PS) conversion device configured for the production of fuels and chemicals such as hydrogen and halogens, although other fuels and chemicals can be produced and are not limiting. For example, halogens such as fluorine, bromine, chlorine, and iodine can be produced.

As described in further detail below, embodiments of a PEC/PS system have at least one electroactive device surrounded by an electrolyte solution. The electroactive device comprises a functional coating disposed over an electrochemically active material. The functional coating is electrically conducting, optically transparent, and corrosion resistant. In some embodiments, the system also comprises an electrocatalytically active material (e.g. reduction catalyst serving as a counter electrode or cathode). In some embodiments, the functional coating can also serve as an electrochemically active material, and can be configured as an oxidation electrocatalyst. In other embodiments, the electrochemically active material is configured as an electrocatalyst, while the functional coating is configured as a conductive protective coating. The oxidation electrocatalysts (anode) and the reduction catalyst (cathode) drive the production of fuels/chemicals (e.g. halogens at the anode and hydrogen at the cathode). In some embodiments, one or both of the electrocatalysts can have a semipermeable coating to prevent any back reactions (e.g. a coating which will allow H⁺ and H₂ but not halogens to the cathode).

A Stable Photoelectrochemical (PEC) System

A PEC cell can, for example, perform electrolysis of water into hydrogen and oxygen gas when an electrode is irradiated with electromagnetic radiation. A PEC cell can be used with semiconductor surfaces as catalysts or in-solution metal complexes as catalysts.

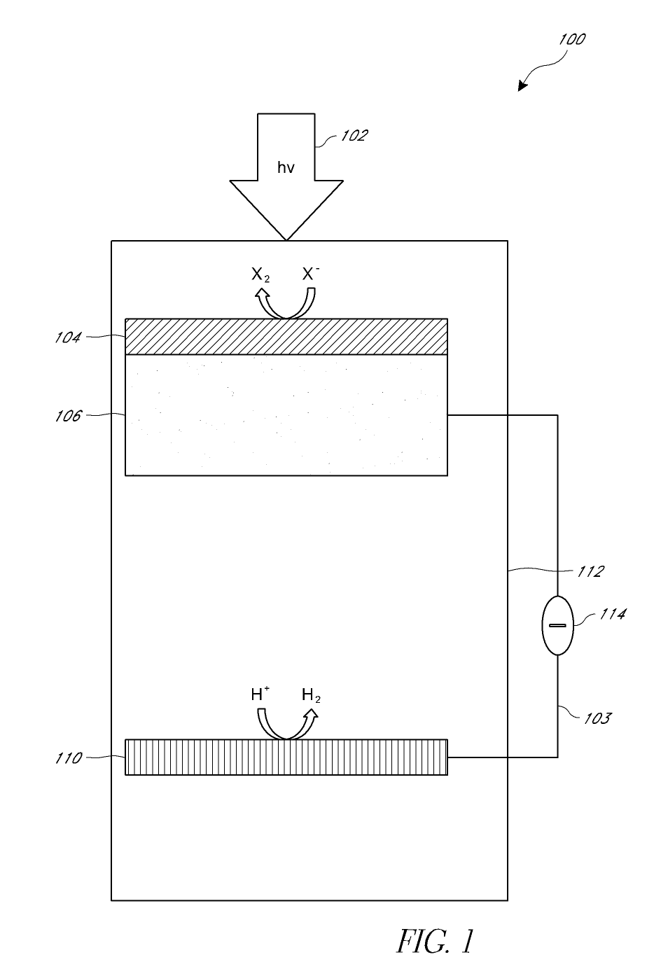

FIG. 1 illustrates an embodiment of a stable PEC system 100. The stable PEC system 100 comprises an anode 101 and a cathode (or counter electrode) 110, wherein the anode and the cathode are immersed in or surrounded by an electrolyte solution 112, and are connected to each other through an external wire 103. The anode 101 comprises an electrochemically active material 106 and a functional coating 104 disposed on the electrochemically active material 106. The anode also comprises an electrochemically active surface. The electrochemically active surface is located at an interface of the polymer coating and the electrochemically active material (e.g., Schottky junction) or within the electrochemically active material (e.g. p-n junction or Schottky junction). In some embodiments, the entire system 100 can be connected to an ammeter 114 to determine any formed current.

In some embodiments, the electrochemically active material 106 comprises a semiconductor material. In some embodiments, the semiconductor material can act as an absorber that is capable of absorbing electromagnetic radiation. In other embodiments, the electrochemically active material 106 further comprises an absorbing material, such as a dye or light-absorbing molecules. Useful semiconductor material may include low band gap semiconductor materials such as silicon (Si), gallium arsenide (GaAs), indium phosphide (InP), cadmium selenide (CdSe), cadmium telluride (CdTe), copper zinc tin sulfide (Cu₂ZnSnS₄), copper sulfide (Cu₂S), tin sulfide (SnS), cadmium sulfide (CdS), iron sulfide (FeS), or a combination thereof. In other embodiments, the electrochemically active material 106 may be dye sensitized TiO₂, for example, TiO₂ with absorbed dye. An example of the dye is a ruthenium-polypyridine dye, but any dye useful for a dye sensitized solar cell can be used. In some embodiments, useful semiconductor may also include sulfides, arsenides, and phosphides. In some embodiments, the electrochemically active surface is a p-n junction or a Schottky junction.

In some embodiments, the semiconductor material is a planar film fabricated using electrodeposition, chemical bath deposition, chemical vapor deposition, molecular beam epitaxy, solvothermal synthesis or a combination thereof. In some embodiments, the semiconductor material is a nanostructured material (wires, rods or particles) fabricated using electrodeposition, chemical bath deposition, chemical vapor deposition, molecular beam epitaxy, solvothermal synthesis or a combination thereof. Nanostructures can also be formed by a combination of wet chemical synthesis and foundry techniques, including lithography and etching. Nanostructing can entail forming semiconductors with at least one of the dimensions in the nanoscale. For example, at least one of the characteristics such as length, width, and thickness can be between about 0.1 and about 100 nm.

In embodiments where the electrode (anode or cathode) is a semiconductor absorber, it may be necessary to from an ohmic contact on the opposite side of the semiconductor material for attaching the wire to the semiconductor for efficient carrier extraction. In embodiments where the electrochemically active material 106 is a dye sensitized TiO₂, an indium tin oxide (ITO) coated glass may be used to collect the current from the electrochemically active material 106.

The electrolyte 112 may be hydrohalic acid (e.g., HCl, HBr, or HI) or acidified brine solution containing Cl⁻, Br⁻, or I⁻. The electrolyte 112 may also comprise a suitable redox couple. Examples of redox couple include Fe²⁺/Fe³⁺, chalcogenides, sulfur, etc.

In general, a method of fabricating a PEC anode comprises providing a electrochemically active material 106, and disposing a functional coating layer 104 on the electrochemically active material 106. A stable PEC system is put together by connecting the anode to a counter electrode (or cathode) 110 through an external wire 103, and suspending the entire unit in an electrolyte 112.

A Stable Artificial Photosynthetic (PS) System

Artificial photosynthesis generally replicates the nature process of photosynthesis, and converts sunlight into useable energy. In some embodiments, the fuel produced from sunlight can be stored and used even when sunlight is not available. For example, sunlight can be used for photocatalytic water splitting which is a method of sustainable hydrogen production. A PS system comprises a photocathode/photoanode, a reduction catalyst (cathode side), an oxidation catalyst (anode side), and an electrolyte. In some embodiments, two different semiconductors can be used as the photocathode/photoanode. In some embodiments, a single semiconductor can be used. A stable PS system further comprises a functional coating on the photoanode/photocathode. In some embodiments, a functional coating can act as a reduction and/or oxidation catalyst.

The basic element of a PS is an independent photosynthetically active heterostructure (PAH). A PAH comprises an electrochemically active material disposed between an anode electrocatalyst and a cathode eletrocatalyst. The electrochemically active material is capable of absorbing electromagnetic radiation. By disposing a functional coating on the electrochemically active material, it serves to protect the electrochemically active material. A photoelectroactive system comprises at least one PAH and an electrolyte, where in the PAH is immersed in the electrolyte. In some embodiments, the transparent functional coating material can also serve as an electrocatalyst. In some embodiments, the PS system comprising at least one PAH is a free-standing entity, and no external wire is required.

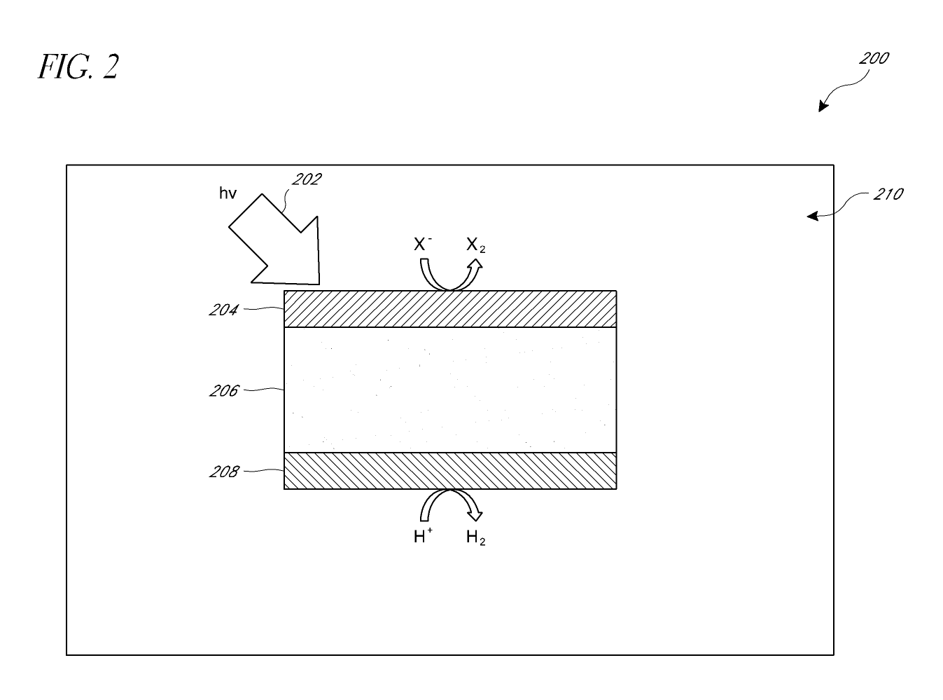

As shown in FIG. 2, upon irradiation by light 202, light absorption occurs in the electrochemically active material 206. The electrochemically action material comprises at least one semiconductor material. In some embodiments, the electrochemically action material for the PS system may form a photovoltaic structure with an electrochemically active surface (e.g. p-n junction or Schottky junction), which can create and separate charge carriers for oxidation on the anode electrocatalyst 204 surface and reduction on the cathode electrocatalyst 208 surface. In some embodiments, the electrochemically active material 206 may be a semiconductor. The structure comprising two electrocatalysts 204 and 208 and the electrochemically active material 206 is the PAH. The PAH is immersed in the electrolyte solution 210 to form the stable PS system 200.

Suitable materials for electrochemically active material 206 and the electrolyte solution 210 are the same as described under Stable PEC System.

A process for fabricating a PAH for a stable artificial photosynthetic (PS) system comprises the steps of: a) providing an electrochemically active material 206; b) disposing a functional coating layer on the electrochemically active material 206; and c) disposing a electrocatalyst layer 208 on the opposite side of the electrochemically active material layer 206.

In some embodiments, an annealing step may be performed after disposing the functional coating material on the electrochemically active material 206. This may facilitate the formation of a Schottky contact or an efficient hole transport layer, which would depending upon the choice and design of the underlying semiconductor layer. In some embodiments, an annealing step may also be performed after disposing the electrocatalyst layer 208 on the opposite side of the electrochemically active material 208 to form an Ohmic contact. The stable PS system is formed by suspending or immersing the PAH in an electrolyte 210.

In some embodiments, a PS system may comprise more than one PAH. For example, multiple PAH units can be fabricated in the pores of a porous structure. The porous structure is nonconductive. In some embodiments, the porous structure is also corrosion resistant in the electrolyte solution. In some embodiments, the porous structure may be a porous anodic aluminum oxide (AAO). The porous AAO can serve as a growth and protective membrane to increase the stability of low band gap semiconductors when dipped in common electrolytes. Anode and cathode electrocatalysts, such as transition metals, can cap the top and bottom of a semiconductor so as to separate the semiconductors from an electrolyte, reducing the chance of corrosion. An additional functional coating on the cathode can allow diffusion of protons and hydrogen but block the oxidation products from reacting and thus increase the Faradaic efficiency for production of hydrogen.

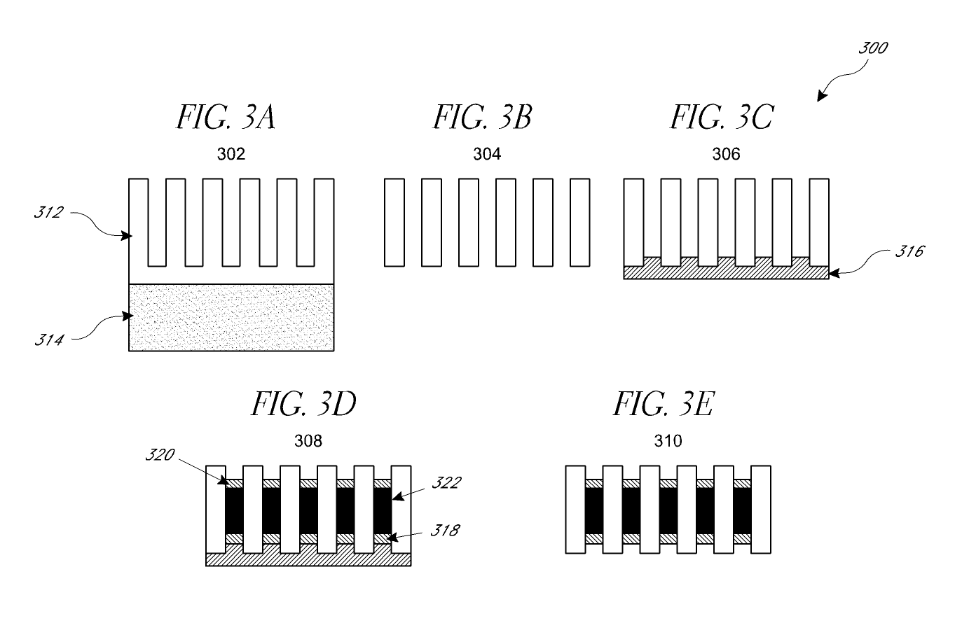

Referring to FIG. 3A, the process 300 can begin in step 302 by forming a porous AAO template 312 by methods known in the art. The AAO 312 may be formed on an underlayer 314, made from, for example, aluminum. The pores of the AAO 312 may be widened or reduced in size to a particular diameter. Referring to FIG. 3B, the AAO template 312 may be removed in step 304 from the underlayer 314 and any remaining alumina barrier layer can be removed by wet or dry etching step. In step 306 (FIG. 3C), a thin metallic film can be physical vapor deposited on one of the sides of porous AAO layer 112 to form an electrically conducting backing layer 316. The material selected for the backing layer 316 can be chosen in such a way that it can be mechanically or chemically etched later on. In step 308 (FIG. 3D), a first electrocatalyst can be deposited into the pores using electrodeposition technique, followed by growing or depositing electrochemically active material 322 in the pores by electrodeposition, and capping the electrochemically active material 322 by depositing a second electrocatalyst. A uniform array of elongated electrochemically active material in the range about 50-about 1000 nm in length and with diameters ranging from about 20-about 200 nm is formed by electrodeposition inside the AAO template 312. In step 310 (FIG. 3E) the backing metallic film 316 is removed. In each of the pores, an electrochemically active material 322 is sandwiched between the first catalyst 318 and the second catalyst 320. The electrochemically active material 322 is the same as described above. In some embodiments, to form an electric field for charge separation, diode junctions (such as CdS/CdTe), or Schottky junctions (such as CdSe/PEDOT:PSS) can be fabricated inside the pores.

The result is a dense array of nanometer sized PAHs separated from each other by a transparent protecting alumina membrane, and each unit within the pores serving as an autonomous solar fuel production unit maximizing the fault tolerance.

A Stable Solar Battery

In some embodiments, a system can serve to exemplify a solar battery process that, for example, splits hydrohalic acids thermochemically (at night) with a metal intermediate that is photoelectrochemically restored (at daylight). The structure of the solar battery comprises a PAH as described above. The PAHs can have the functional coating material 1204 such as PEDOT:PSS to prevent photocorrosion. In some embodiments, a functional coating as described above can be coating on one surface of the battery, or can wrap completely around the battery.

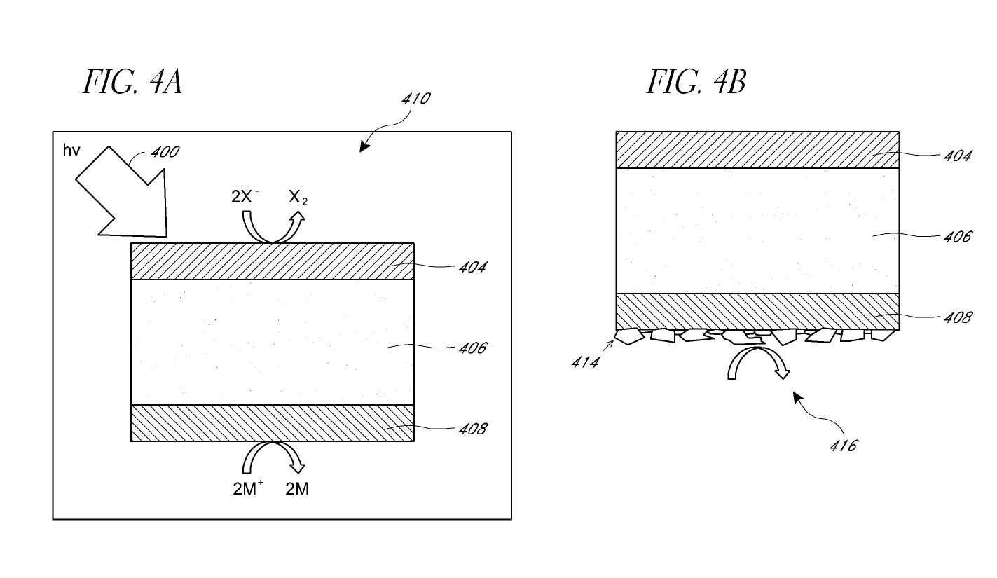

Referring to FIG. 4A, in some embodiments the process comprises perform photoelectolysis of metal halide solution 410 (MX, wherein M may be Cu, Ag, etc., and X is Cl, Br, or I. e.g., copper bromide) under the illumination of light 400. This process results in a photoelectrochemical dposition of copper at the cathode side 408 and bromine evolution at the anode side 404. The bromine formed can be separated by gravitational methods or phase separated by using a complexing agent such as poly ethylene glycol (PEG). At night, referring to FIG. 4B, the PAH unit with the deposited copper 414 then goes through a reverse reaction 416 to produce a fuel or electricity. The deposited copper 414 is can either be oxidized in hydrobromic acid/gas to evolve copper bromide and H₂ (2M⁺+HX→MX+H₂) or reacted with bromine to generate electricity and copper bromide (2M⁺+X₂→MX+electricity).

### A Transparent Conducting Substrate for Solar Cells

The functional coating may also be used to provide a transparent conducting substrate, which can be used as a part of the anode structure in solar energy conversion devices. One type of such a device can comprise: a) a transparent substrate (such as glass, quartz, mica, PET, etc.); b) a functional coating material disposed on the substrate; c) an electrically conducting substrate as cathode; and d) a diode junction (such as CdS/CdTe) or Schottky junction (such as CdSe/PEDOT:PSS or CdS/Au) in contact with the functional coating material.

### Antistatic Devices

In some embodiments, the functional coating can be used as a transparent antistatic coatings. An antistatic device can prevent a buildup of static electricity, which can result in electrostatic discharge, thereby causing damage to electronic parts and/or in some cases can result in electric sparks which could set off a fire or explosion. In some embodiments, an antistatic device can be formed from an antistatic agent, such as the functional coating described above, that can be coated on shock sensitive surfaces or materials in order to eliminate a buildup of static electricity. One end of the device can be connected to a ground conductor through, for example, a high resistor, which can allow high voltage charges to leak through, thereby preventing any electrical shocks.

### A Stable Functional Composite Coating Material for Fuel Cell Application

In some embodiments, a functional coating as described above can be coating on one surface of the fuel cell, or can wrap completely around the fuel cell. The functional coating may serve as an electrocatalyst for fuel cell applications.

In some embodiments, a fuel cell device comprises: a) an anode catalyst layer; b) a cathode catalyst layer; and c) a proton exchange polymer membrane such as Nafion between the anode catalyst layer and the cathode catalyst layer. The proton exchange membrane allows only the positively charged ions to pass through it to the cathode. In some embodiments, the anode catalyst layer may comprise platinum nanoparticles in carbon paper, which can cause hydrogen to oxidize to positive hydrogen ions. In some embodiments, the cathode catalyst layer is a functional composite coating material such as PEDOT:PSS infiltrated in carbon paper support, which can promote the electrochemical reduction of the oxidant such as O₂ or Br₂. The functional coating material can be disposed by spin coating, spray painting, vapor phase polymerization or combinations thereof.

In some embodiments, the electrocatalytic activity of the functional coating polymer can be further enhanced by adding inclusions to the polymerin some embodiments, the inclusions can be nanoparticles or nanowires. The inclusions can be formed from materials like platinum, iridium, ruthenium, ruthenium oxide, ruthenium sulfides, rhodium sulfide, and combinations thereof. Other materials for the inclusions can include metals, metal oxides, and other inorganic materials. The size, shape, and type of the inclusions are not limiting. In such embodiments, the material can be added as nanoparticle/nanowire inclusions during the coating step or added on top upon completion of the coating step. The inclusions can act as co-catalysts, and can improve the overall electro-catalytic activity of the device.

### Inexpensive Dye Sensitized Solar Cell (DSSC)

In some embodiments, a functional coating material coated glass may be used as a counter electrode in a DSSC, replacing expensive platinum electrodes. In some embodiments, the functional coating material coated glass may also be used as an anode. The DSSC can be tuned toward different redox electrolytes. One type of DSSC is a Gratzel cell.

In some embodiments, a DSSC comprises: a) a conductive transparent anode; b) a thin layer of highly porous TiO₂ layer disposed on of the transparent anode; c) a photosensitizer such as ruthenium-polypyridine dye disposed on the TiO₂ layer; and d) an electrolyte containing redox mediator such as I⁻/I₃⁻ between the anode and a cathode.

In some embodiments, the cathode can be made of PEDOT:PSS coated glass. In some embodiments, the anode can be made of conductive transparent sheet of fluorine doped tin oxide on glass. In some embodiments, both the anode and cathode can be made of PEDOT:PSS coated glass. In some embodiments, the functional coating material, such as PEDOT:PSS, can be disposed by electrodeposition, vapor phase deposition, spin casting, drop casting, spray painting, or combinations thereof.

### A Stable Current Collector for Batteries

Continued corrosion of current collectors such as copper or aluminum in, for example, lithium ion batteries, can lead to gradual increase in the internal resistance of the cell or, in worst case, may induce a short-circuit affecting its safety, an electrically/electrochemically stable functional coating on the current collector surface can be used to increase long term battery performance and safety.

For example, PEDOT:PSS disposed on current collectors such as copper, iron etc. or on its own can act as a current collector. In some embodiments, the smooth nature of the film morphologies obtained with PEDOT:PSS coating may reduce dendrite growth formation, thereby reducing the problem of short-circuiting. Other types of batteries can be used in the above disclosure such as, for example, lithium iron phosphate or lithium air batters, and the type of battery is not limiting.

In some embodiments, the methods of disposing the functional coating material on current collector and on battery electrode material disclosed above can be in-situ electrodeposition during battery charging and discharging cycle, or can be disposed prior to battery assembly using electrodeposition, vapor phase deposition, spin casting, drop casting, spray painting, and/or combinations thereof.

The functional coating material can protect electroactive devices from chemical/electrochemical/photo corrosion enabling it for long term efficient operation. In some embodiments, the operation of the devices can last for at least about 10, at least about 20, at least about 30, at least about 40, at least about 50, at least about 60, at least about 70, at least about 80, at least about 90, or at least about 100 days. In some embodiments, the operation can last for 72 days or more. The above disclosed process and techniques points the way to large scale, inexpensive, hybrid organic-inorganic solar-to-chemical conversion systems.

The examples provided below are to illustrate in detail some of the embodiments of the present disclosure. It should be understood by those proficient in the art that the above discussion and the techniques disclosed in the following systems along with processes which follow the techniques should be considered as exemplary, and can be made by making many or slight changes in the disclosed embodiments to obtain alike or parallel results without deviating much from the essence and scope of the disclosure.

### Example 1

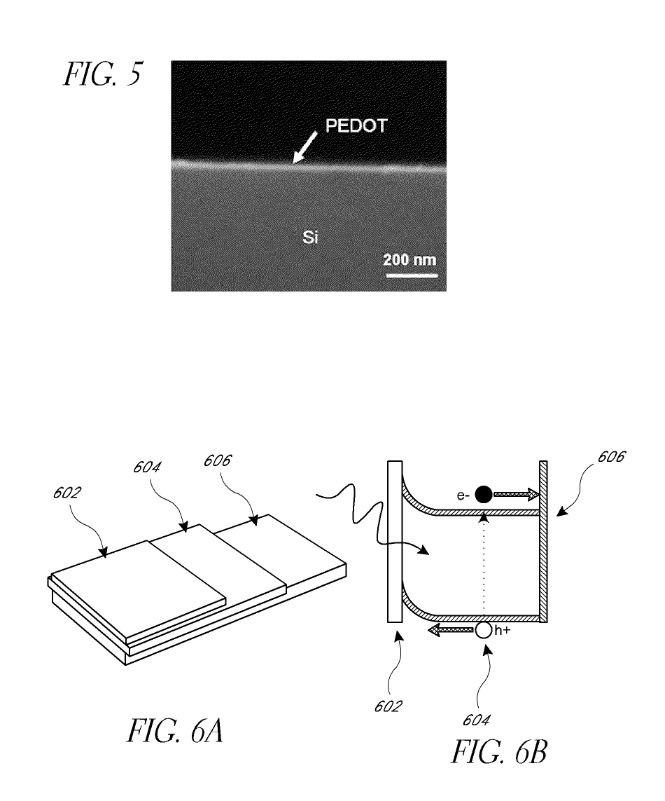

Stable PEC system: Phosphorous doped n-Si wafers was used as a photoelectrode for the photoelectrolytic cell. The silicon wafer was first treated with buffered HF to remove a native oxide layer before disposing a functional coating. To achieve conformal coating, PEDOT:PSS in 5 v/v % dimethyl sulfoxide (DMSO) was spin coated on the polished side of the Si wafer, followed by annealing in air at about 120° C. for about 10-about 30 minutes to evaporate the solvent. The surface of the PEDOT:PSS film was further modified to prevent delamination effects during electrolysisby dip coating the film in ethylene glycol (EG), which can render the polymer film water-insoluble. Aluminum was then e-beam evaporated on the back side as an Ohmic contact. The cross sectional scanning electron micrograph (SEM) image in FIG. 5 shows an embodiment of a thin PEDOT:PSS polymer coating on the surface of a Si photoelectrode. No additional electrocatalyst was required for PEC operation, hence not compromising the transmission of sunlight to the Si substrate.

The PEC properties of an embodiment of the PEDOT:PSS coated Si photoanode were measured using a two electrode configuration. A schematic representation of the PEC photoanode with a corresponding band diagram is shown in FIGS. 6A and 6B. The PEC photoanode comprises a polymer coating 602, a semiconductor layer 604, and a bottom ohmic contact 606. As illustrated in FIG. 6B, when sunlight is absorbed by the semiconductor layer 604, electrons and holes are separated, and the electrons are drawn to the ohmic contact 606 while the holes move toward the polymer coating 602/semiconductor 604 interface.

### Example 2

The functional coating can act as an efficient carrier mediator layer transferring the extracted carriers from the photovoltaic site to the electrochemical reaction site. The electron transfer kinetics, as measured by the one electron redox couple of:

K₃[Fe(CN)₆](Fe(CN)₆³⁻+e- [symbol] Fe(CN)₆⁴⁻)

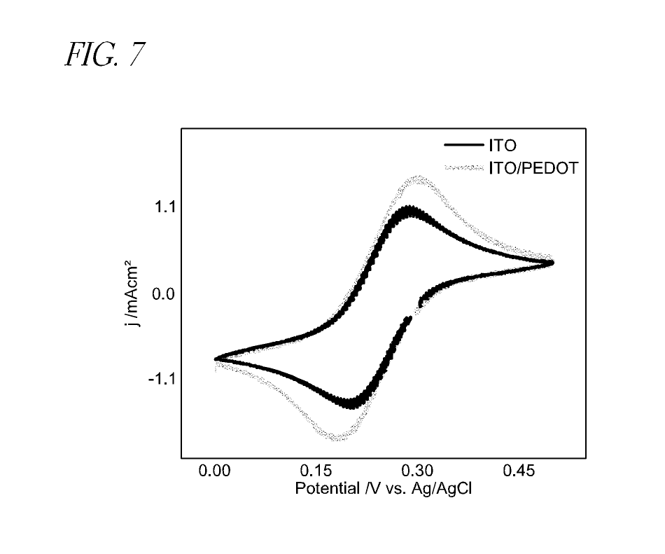

provides a suitable technique to examine the electrochemical activity and is widely used as an electrochemical probe to investigate the characteristics of films on electrode surfaces. The cyclic voltammetry (CV) of K₃[Fe(CN)₆] at both the bare ITO electrode surface and the ITO electrode covered by a 20 nm thick PEDOT:PSS film were recorded in an 1 M KCl solution containing 20 mM potassium ferricyanide (K₃[Fe(CN)₆]). The CV curves in FIG. 7 illustrate the electronic transfer kinetics of the PEDOT:PSS films on an ITO electrode. The CV curve of the bare ITO electrode shows the expected reversible electrochemical response for K₃[Fe(CN)₆] with peak separation (the potential difference between the oxidation peak potential and the reduction peak potential) of 85 mV at 100 mV s⁻¹. Coating the ITO electrode with a 20 nm layer of PEDOT:PSS polymer film did not compromise the electronic communication between the substrate and the electrolyte. Nearly reversible CV's of K₃[Fe(CN)₆], and larger peak current and peak separation (115 mV) matching closely that obtained for the bare ITO electrode were observed.

### Example 3

The photoelectrochemical performances of a Si/PEDOT:PSS composite anode and a n-Si anode in different electrolyte solutions (I⁻/I₃⁻ redox couple, HBr) are compared. Each electrode was immersed in aqueous I⁻/I₃⁻ solution, and the voltammetric curves were recorded in dark and under simulated illumination of 35 mW cm⁻². The same experiment was also done in HBr solution. I-V (current-voltage) curve measurements were performed using a commercial IV tester (a DC power source) and a stable light source. From the I-V curves, short circuit current density (J_{SC}) and open circuit voltage (V_{OC}) were determined. The fill factor (FF) and power conversion efficiency (PCE) were then calculated. The J_{SC} is defined as the current through the solar cell when the voltage across the solar cell is zero, divided by the illuminated electrode area. Voc is defined as the maximum voltage available from a solar cell, which occurs at zero current. FF is defined as the ratio of maximum power of the solar cell to the product of Voc and J_{SC}. The PCE is defined as a fraction of incident power that is converted to electricity and is given as (Voc*J_{SC}*FF)/incident light intensity.

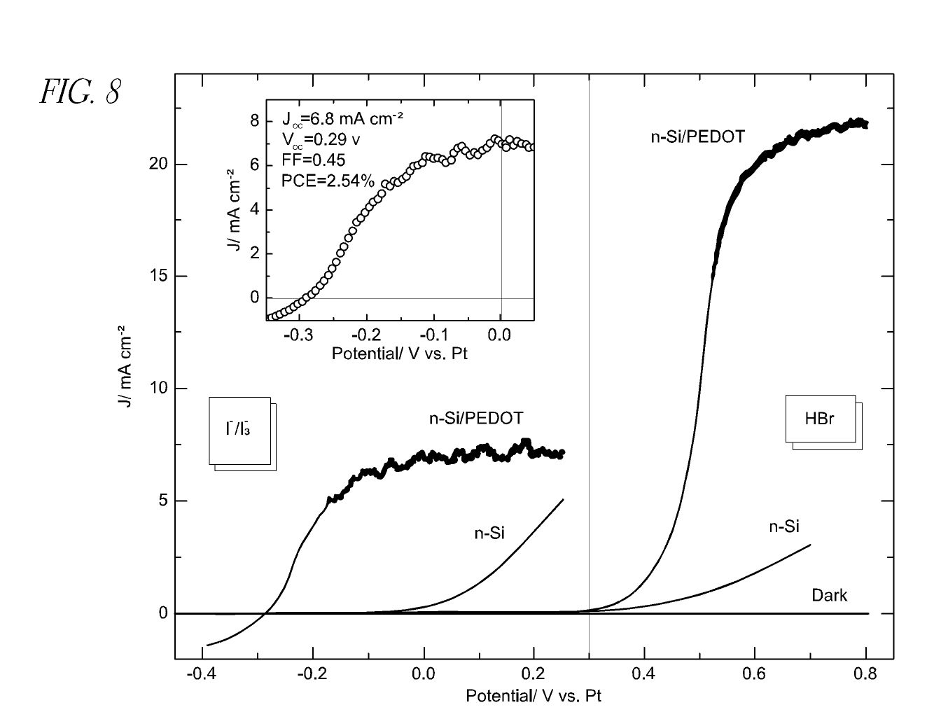

FIG. 8 shows the I-V curves of both the n-Si/PEDOT:PSS composite anode and n-Si anode in two different electrolyte solution, in dark and under illumination, The PEDOT:PSS coated n-Si electrode performed well in different solutions without a separate catalyst. In aqueous I⁻/I₃⁻, the planar n-Si electrode with no coating exhibits very low J_{SC} (0.2 mA cm⁻²), Voc (0.11 V), FF (0.2), and PCE (0.012%). In comparison, the n-Si electrode with PEDOT:PSS coating exhibited much better performance with a high J_{SC} (6.82 mA cm⁻²), Voc (0.29 V), FF (0.45), and PCE of 2.54%.

However, in some embodiments, texturing can readily be done on the PEDOT:PSS coated devices, as further described below. The at least 2× increase in open circuit voltage observed for the PEDOT:PSS coated n-Si electrode compared to the uncoated electrode may be due to the formation of a Schottky barrier between the conducting PEDOT:PSS polymer and n-Si electrode. Furthermore, high fill factors observed for the PEDOT:PSS coated Si anode demonstrates its role as an efficient charge carrier. These anodes were active in toxic, corrosive and volatile HBr solution having modest over potentials to achieve a current density of 1 mA cm⁻². The above results were obtained using the as-received n-Si wafers without additional surface texturing or anti-reflection coating, which is typical in commercial photovoltaics to improve efficiency.

### Example 4

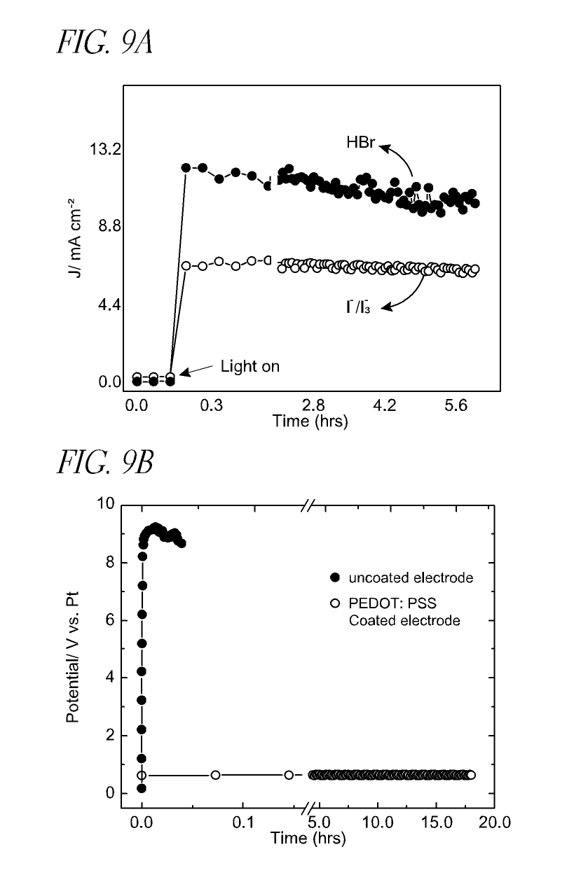

Stability tests of the PEDOT:PSS coated Si electrode was also performed by measuring the photocurrent obtained on the electrode over time while holding the electrode at a constant potential of 0.6 V versus Pt electrode. The photoelectrode was immersed in an aqueous electrolyte containing I⁻/I₃⁻ pair (red trace) or HBr for about 6 hours under continuous illumination at 35 mW cm⁻². FIG. 9A shows no deterioration in short-circuit currents in the aqueous electrolyte containing I⁻/I₃⁻. The PEDOT:PSS coated Si anode also displayed remarkable stability in the highly corrosive and toxic HBr solution. FIG. 9B shows the measured potential used for a constant current of 10 mA cm⁻² at the photoanode in HBr solution under illumination with and without the functional PEDOT:PSS layer. The uncoated samples failed immediately with voltages reaching the maximum measurable voltage (9V) to maintain the constant current; whereas the PEDOT:PSS-coated samples showed stable photovoltages for at least about 18 hours of continuous illumination.

### Example 5

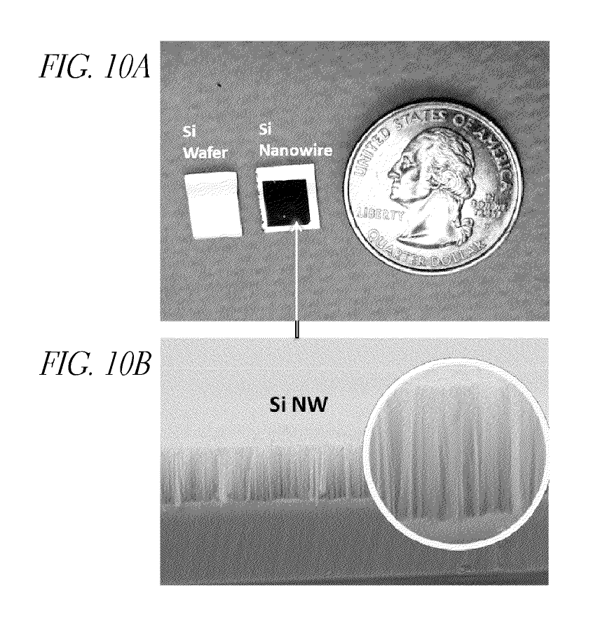

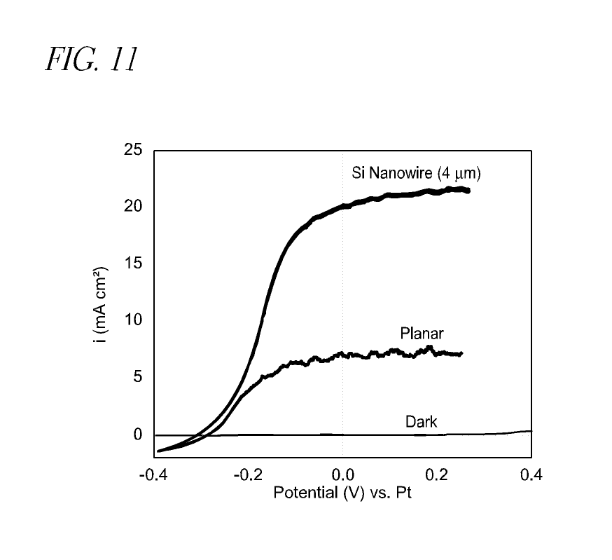

Nanostructured semiconductor surface can have improved optical absortion compared to a planar semiconductor surface. FIG. 10A shows evidence of improved optical absorption and decreased reflection losses on nanostructuring. As shown, the nanostructured semiconductor has a darker color, which is indicative of more light being absorbed, and less being reflected. FIG. 10B is a scanned electron micrograph of the cross-section of the nanostructured semiconductor layer. FIG. 11 shows the effect of nanostructuring on photoelectrochemical performance of an embodiment of a n-Si/PEDOT:PSS system in I⁻/I₃⁻ redox couple under simulated illumination of 35 mW cm⁻². Compared to the planar wafer, nanowires on a Si wafer improved the photoelectrochemical performance by at least fourfold.

### Example 6

A wireless PS cell utilizing p-n GaAs junction as the electrochemically active surface was fabricated by e-beam depositing platinum at the cathode side (n-side) and spin casting PEDOT:PSS on the anode side (p-side). In this case, PEDOT:PSS serves as both transparent conducting hole transport layer and as an electrocatalyst for bromine evolution. The open circuit voltage for p-n GaAs junction cells is about 1V, which can perform wireless HBr electrolysis.

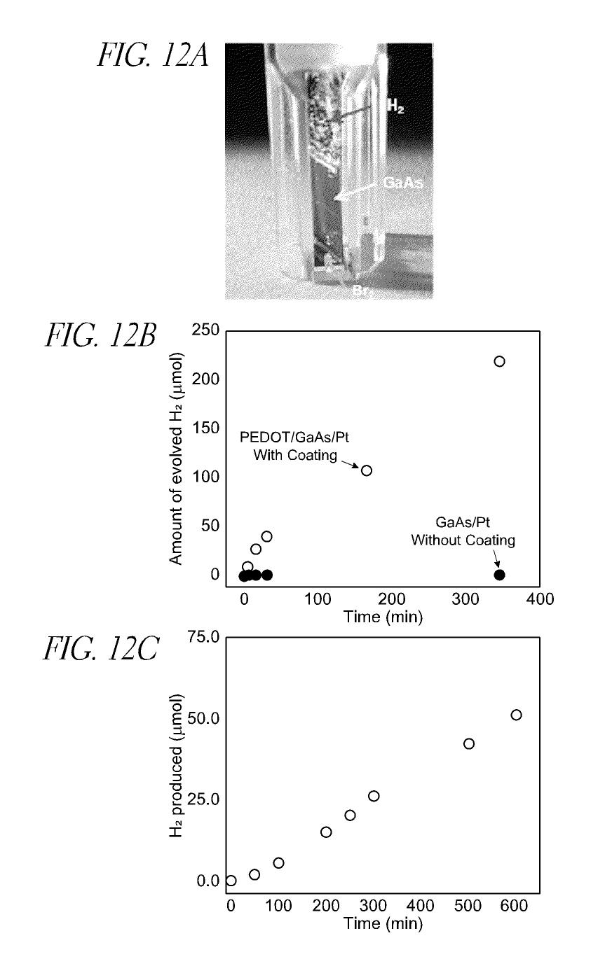

As shown in FIG. 12A, upon illumination, clear visual observation of H₂ bubbles on the cathode and bromine evolution at the anode can be obtained. With no PEDOT:PSS coating, the cells failed immediately in HBr. The stability of the PS unit was assessed by measuring the hydrogen production using a gas chromatograph (GC) column in a closed cell configuration. As shown in FIG. 12B, the cell was stable for about 6 hours of continuous operation. Since it is well known that Pt corrodes during HBr electrolysis, long term operation was determined by the stability of the Pt electrode for H₂ evolution. Approaches like using ruthenium sulfide or rhodium sulfide as opposed to Pt for H₂ evolution can be employed to improve the stability of the cells for HBr electrolysis. As shown in FIG. 12C, similar results were observed for stand-alone Si/PEDOT:PSS Schottky photosynthetic cells in I⁻/I₃⁻ redox electrolyte, which produced sustainable H₂ for long periods of time.

Although the present disclosure includes certain embodiments, examples and applications, it will be understood by those skilled in the art that the present disclosure extends beyond the specifically disclosed embodiments to other alternative embodiments and/or uses and obvious modifications and equivalents thereof, including embodiments which do not provide all of the features and advantages set forth herein. Accordingly, the scope of the present disclosure is not intended to be limited by the specific disclosures of preferred embodiments herein, and may be defined by claims as presented herein or as presented in the future.

1. A stabilized electroactive system comprising:
an electroactive device comprising an electrochemically active surface, a electrochemically active material, and a polymer coating disposed over the electrochemically active material; wherein the polymer coating is electrically conducting, optically transparent, and corrosion resistant; and.
an electrolyte solution contacting at least a portion of the polymer coating.

2. The system of claim 1, further comprising a counter electrode.

3. The system of claim 1, wherein the electroactive device further comprises a reduction electrocatalyst material disposed on an opposite side of the electrochemically active layer.

4. The system of claim 3 comprising a plurality of electroactive devices.

5. The system of claim 4, wherein the plurality of electroactive devices are disposed in pores of a porous structure.

6. The system of claim 5, wherein the porous structure is an anodic aluminum oxide.

7. The system of claim 1, wherein the polymer coating is configured to be an oxidation electrocatalyst material.

8. The system of claim 1, wherein the electrochemically active material comprises a semiconductor material.

9. The system of claim 8, wherein the semiconductor material is selected from the group consisting of CdTe, CdSe, Si, GaAs, InP, CdS, Cu₂S, SnS, Cu₂ZnSnS₄, FeS and a combination thereof.

10. The system of claim 1, wherein the electrochemically active surface is a p-n junction or a Schottky junction.

11. The system of claim 1, wherein the electrochemically active surface is located at an interface of the polymer coating and the electrochemically active material or within the electrochemically active material.

12. The system of claim 1, wherein the electroactive device further comprises a transparent substrate disposed on the polymer coating, and the polymer coating is disposed on the electrochemically active material.

13. The system of claim 1, wherein the electrochemically active material comprises dye sensitized TiO₂.

14. The system of claim 1, where in the polymer coating is selected from the group consisting of poly(3,4-ethylenedioxythiophene) (PEDOT), poly(4,4-dioctylcyclopentadithiophene), metallic carbon nanotubes (CNTs), and a combination thereof.

15. The system of claim 14, wherein the polymer coating is doped by at least one dopant selected from the group consisting of styrene sulfonate (PSS), tetra methacrylate (TMA), perchlorate iodine, 2,3-dichloro-5,6-dicyano-1,4-benzoquinone (DDQ) and a combination thereof.

16. The system of claim 15, wherein the polymer coating comprises PEDOT:PSS.

17. The system of claim 1, where in the polymer coating further comprises a plurality of nanoparticles or nanowires, wherein the plurality of nanoparticles and nanowires are metal, metal oxide, semiconductor, or a combination thereof.

18. The system of claim 1, wherein the system further comprises a semipermeable coating on the polymer coating, wherein the semipermeable coating comprises chromium oxide, poly(methyl methacrylate), or a combination thereof.

19. (canceled)

20. The system of claim 1, wherein the system remains stable for at least about 18 hours of continuous illumination.

21. The system of claim 1, wherein the system is configured as a photoelectochemical cell, an artificial photosynthetic cell, or a solar battery.
